(19) United States
(12) Patent Application Publication
(10) Pub. No.: US 2013/0088494 A1
(43) Pub. Date: Apr. 11, 2013

(54) VISUAL DISPLAY BASED ON THE NUMBER OF USERS AT OR NEAR A LOCATION

(71) Applicant: Kristopher Carlos ORTIZ, Annapolis, MD (US)

(72) Inventor: Kristopher Carlos ORTIZ, Annapolis, MD (US)

(21) Appl. No.: 13/401,742

(22) Filed: Feb. 21, 2012

Related U.S. Application Data
(60) Provisional application No. 61/543,440, filed on Oct. 5, 2011.

(51) Int. Cl. G06T 11/20; H04L 27/00

(52) U.S. Cl. 345/440; 375/295

(57) ABSTRACT

A system, apparatus, and method for the visual display of data pertaining to crowd activity is provided, including receiving and storing information pertaining one or more pulses having respective locations. Also, the one or more pulses are displayed at positions corresponding to the respective locations on a mapping application via a display of an electronic device. Visual attributes of the one or more pulses pertain to, and are displayed based on, crowd data for a location or area associated with the pulse.

### CROSS REFERENCE TO RELATED APPLICATIONS

This application claims priority to U.S. Provisional Patent Application Ser. No. 61/543,440, filed Oct. 5, 2011. The subject matter of this earlier filed application is hereby incorporated by reference in its entirety.

### FIELD

The present invention generally pertains to facilitating a visual display, and more specifically, to facilitating a visual representation of a number of users at or near a given location of interest.

### BACKGROUND

Software applications providing location-based services by taking advantage of Global Positioning System (GPS) technology have rapidly increased in popularity in recent years. For instance, via foursquare®, users can check into locations via their cell phones to let their friends know where they are and what they are doing. Users can also discover what locations of interest, such as restaurants, bars, and hotels, are in close proximity using cell phone applications such as AroundMe™. Further, users can view their current location, as well as see maps and locations of interest, using applications such as Google® Maps and rate locations or list their business using Google Places®. However, applications that provide useful representations of crowd data for locations and events are not conventionally available.

### SUMMARY

Certain embodiments of the present invention may provide solutions to the problems and needs in the art that have not yet been fully solved by conventional mapping and social networking software applications. For example, certain embodiments of the present invention may collect and display visual attributes such as size, color, and/or frequency of pulses based on data such as the number of users at a certain location, time that users spend at a given location, etc. In some embodiments, information may be collected, and a display may be updated, in real time or near real time.

In one embodiment of the present invention, a computer-implemented method includes receiving and storing information pertaining one or more pulses having respective locations. The computer-implemented method also includes displaying the one or more pulses at positions corresponding to the respective locations on a mapping application via a display of an electronic device. Visual attributes of the one or more pulses pertain to, and are displayed based on, crowd data for a location or area associated with the pulse.

In another embodiment of the present invention, an apparatus includes physical memory, a processor configured to read information from, and write information to, the physical memory, and a display. The processor is configured to receive and store information pertaining one or more pulses having respective locations. The display is configured to display the one or more pulses at positions corresponding to the respective locations on a mapping application via a display of an electronic device. Visual attributes of the one or more pulses pertain to, and are displayed based on, crowd data for a location or area associated with the pulse.

In yet another embodiment of the present invention, a computer-implemented method includes receiving and storing data pertaining to a pulse. The data includes a total number of users at a pulse location, a number of users entering the pulse location within a predetermined period of time, and a number of users leaving the pulse location within a predetermined period of time. The computer-implemented method also includes transmitting the data to at least one electronic device.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a system for facilitating a visual display based on a number of users at or near a location, according to an embodiment of the present invention.

FIG. 2 illustrates a mapping application on a GPS-enabled electronic device, according to an embodiment of the present invention.

FIG. 3 illustrates a pulse category selection menu on the GPS-enabled electronic device, according to an embodiment of the present invention.

FIG. 4 illustrates a nearby pulses screen on the GPS-enabled electronic device, according to an embodiment of the present invention.

FIG. 5 illustrates a pulse description on the GPS-enabled electronic device, according to an embodiment of the present invention.

FIG. 6 illustrates a telecommunications system, in accordance with an embodiment of the present invention.

FIG. 7 illustrates a flowchart of a method for facilitating a visual display based on a number of users at or near a location, according to an embodiment of the present invention.

FIG. 8 is a flowchart illustrating a method of collecting and managing pulse data for a plurality of users, according to an embodiment of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of the systems, apparatuses and methods of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

Some embodiments of the present invention provide a visual representation of user activity in a given location or area through GPS-enabled electronic devices, such as cell phones, automobile navigation systems, and handheld personal navigation systems, among others. Representations of user activity may also be passed to, and displayed on, non-GPS-enabled devices, such as certain personal computers, servers, and the like. A location may be effectively defined and implemented as a distance from a given central point in some embodiments. An area may be effectively defined and implemented as a bounded region of any shape defined by coordinates in some embodiments. Either or both mechanisms may be used to identify a location that represents an event or a physical establishment, such as a restaurant, a bar, a stadium, an area within a park, etc.

Activity in a given location or area may be represented by visual “pulses” that are round or any other desired shape. These pulses may have attributes representative of group-based information, such as color, size, opacity, pulse color intensity, and pulse flash speed. Further, where display technology enables such features, pulses may be three-dimensional. Pulses may be always available, such as those associated with a certain establishment, or may be event-based, starting and ending at a predetermined time.

In some embodiments, color may indicate the type of event taking place at a given location and/or area. For instance, restaurants may be shown in red, bars may be shown in blue, entertainment may be shown in purple, sports may be shown in orange, and group activities may be shown in green. The color assigned to the event may be designated by the user of the application or the designer of the application. The color used for a certain location or area may vary with the type of event. For instance, a pulse associated with an arena may appear in purple one night when a rock concert is taking pace, and a pulse associated with the arena may be orange the next night during a basketball game. Similarly, a pulse for an area such as a certain portion of the Washington Mall may appear green when a rally is taking place one day and may be purple for an outdoor music festival another day. Any category and representative color designation may be chosen and represented. Further, the same pulse or a different pulse may be used to represent the same location or area for different days, events, etc.

The size of the pulses may also be used to provide certain information to the user. For example, the size may indicate the number of users that have checked into an event. In some embodiments, the number of users that are expected to check into the event may be taken into account. For example, a given pulse may be a predetermined size, such as one centimeter, a certain number of pixels in radius, etc. if the expected number of users has checked into the event. If fewer users have checked in than expected, the pulse may be smaller than the predetermined size, and if more users have checked in than expected, the pulse may be larger than the predetermined size. In other embodiments, the size of all pulses may be based on a number of users, or the basis may change per category. For instance, for a small location such as a coffee shop, the size may increase by one pixel for every user present, and for a large location such as a stadium, the size may increase by one pixel for every 100 or 1,000 users.

Opacity may be used to show event or location saturation. For example, if the number of users that have stayed in a location or area relative to the total capacity of the event or venue, the pulse may appear to be more opaque. However, if a relatively large number of users have left the event or location, the pulse may be shown as more transparent. Furthermore, the transparency/opacity may be based on the number of users that have left within a predetermined time period, such as the last ten minutes. Transparency/opacity may indicate to a user that an event or location is less popular than expected, or conversely, indicate that an event or location may be becoming less crowded and thus more likely to have seats available, which may better suit certain users' preferences.

Pulse intensity may indicate the number of users that have checked into an event or location within a certain time period, such as the last 10 minutes. This intensity may be shown as a faster pulsation or beating for many user check-ins and slower for fewer check-ins. Alternatively, the pulsation may change to indicate a higher or lower number of users. The intensity may also be relative to the total number of users that are expected to come to the event.

A pulse may also flash with a certain frequency. For instance, the frequency of the flashing may indicate the number of posts, such as messages, videos, tweets, pictures, etc., sent from a pulse location within a predetermined time period. This may also be modified in relation to the total number of users that are at the event or location. Pulses may flash when a single user enters a pulse location, when the number of users entering a pulse location exceeds a certain threshold, when a single or a predetermined number of posts occur, or to indicate any desired event or occurrence. A person of ordinary skill in the art will readily appreciate that the pulse attributes that are used, as well as what each pulse attribute is selected to represent, are matters of design choice and all variations are envisioned to be within the scope of at least some embodiments of the present invention. Further, embodiments of the present invention may be presented as a stand-alone software application, or may be integrated into other software applications as part of the main application code, as add-ons, plugins, or via any other suitable means.

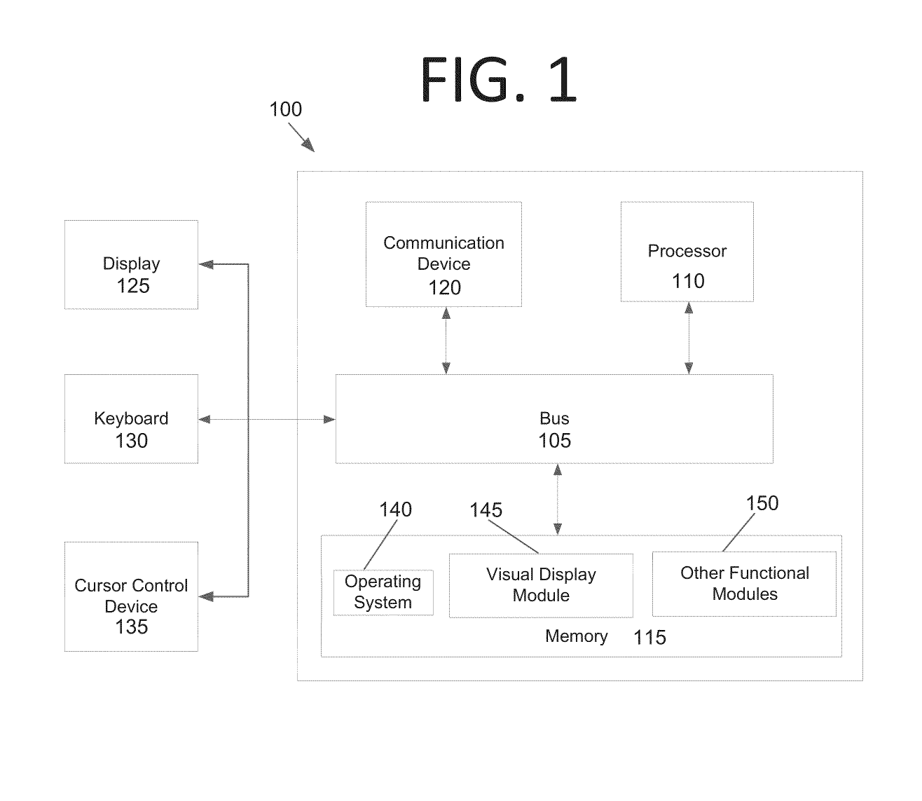

FIG. 1 illustrates a system 100 for presenting a visual display based on a number of users at or near a location, according to an embodiment of the present invention. System 100 includes a bus 105 or other communication mechanism for communicating information, and a processor 110 coupled to bus 105 for processing information. Processor 110 may be any type of general or specific purpose processor, including a central processing unit (CPU) or application specific integrated circuit (ASIC). System 100 further includes a memory 115 for storing information and instructions to be executed by processor 110. Memory 115 can be comprised of any combination of random access memory (RAM), read only memory (ROM), flash memory, cache, static storage such as a magnetic or optical disk, or any other types of non-transitory computer-readable media or combinations thereof. Additionally, system 100 includes a communication device 120, such as a wireless network interface card, to provide access to a network.

Non-transitory computer-readable media may be any available media that can be accessed by processor 110 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 110 is further coupled via bus 105 to a display 125, such as a Liquid Crystal Display (“LCD”), for displaying information to a user. A keyboard 130 and a cursor control device 135, such as a computer mouse, are further coupled to bus 105 to enable a user to interface with system 100.

In one embodiment, memory 115 stores software modules that provide functionality when executed by processor 110. The modules include an operating system 140 for system 100. The modules further include a visual display module 145 that is configured to present a visual display based on a number of users at a location. System 100 may include one or more additional functional modules 150 that include additional functionality

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

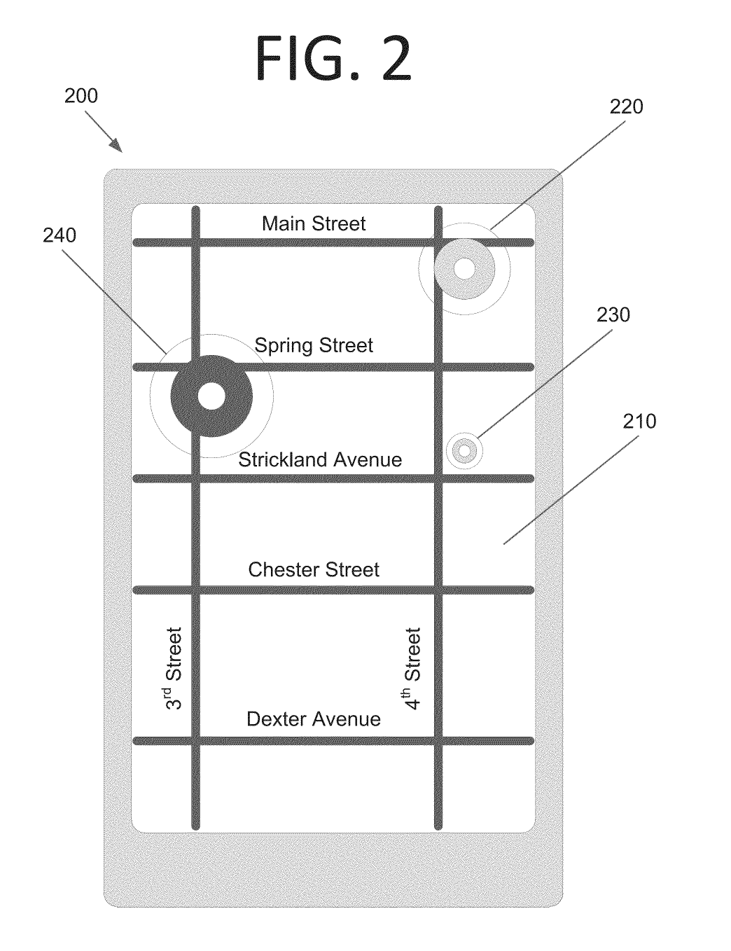

FIG. 2 illustrates a mapping application 210 on a GPS-enabled electronic device 200, according to an embodiment of the present invention. In some embodiments, GPS-enabled electronic device 200 may include system 100 of FIG. 1. GPS-enabled electronic device 200 has a screen that displays a Graphical User Interface (GUI) for various software applications. In FIG. 2, the screen is displaying mapping application 210. In many embodiments, the pulse tracking and display functionality will be integrated into existing mapping and/or social networking software applications as an added feature.

In FIG. 2, three pulses 220, 230, and 240 are shown on the mapping application. The pulses may be color-coded to indicate the type of location or event that they represent. For instance, pulses 220 and 230 may represent restaurants and pulse 240 may represent a bar. The pulses have different sizes that may represent a number of subscribers to the software application, cell phone users, or any other suitable grouping of individuals from which data may be collected and shared. In order to alleviate potential privacy concerns, the identity of users that are present at a given pulse location may be anonymous or only shared with other trusted users, such as friends.

In the present embodiment, the pulses have different colors, rings, and/or other attributes, as desired by the designer. Further, some rings within a pulse may be completely transparent, as is the case with the outer ring, may be completely solid, as is the case with the middle ring, or may have varying levels of transparency/opacity. Pulses may flash at varying speeds, and the rings may migrate at a certain speed from the center of the pulse outward or from the outside of the pulse inward. Each ring may also fade in transparency and/or color from the center of the ring outward, from the outside of the ring towards the center thereof, or in any other desired fashion. The features of the pulse represented in FIG. 2 are merely illustrative, and what each attribute of a pulse represents, the shape of the pulse, and all other design features thereof are a matter of design choice.

As discussed above, various attributes may be represented via pulses. In cellular telephone networks or various other client/server systems, data may be shared between a server application collecting data from a number of users and a user's cell phone, for instance. In such systems, the data fields such as the following may be used to identify and provide relevant data for a consuming software application to process and display pulses and events. The fields may have any desired name or type, and may be in one or more tables as a matter of design choice.

TABLE 1
DATA FIELDS

| Data Field Name | Data Field Type | Description |
|---|---|---|
| PULSE_ID | INTEGER | A unique identifier of a pulse. |
| PULSE_TYPE | INTEGER | An indication of the type of |
| | | the pulse. For example, “1” |
| | | may indicate that the pulse is |
| | | associated with a restaurant |
| | | and “2” may indicate that the |
| | | pulse is associated with a |
| | | sporting event. |
| PULSE_NAME | VARCHAR(50) | A name of the pulse location |
| | | or area, such as “Joe's Pub”. |
| PULSE_DESC | VARCHAR(400) | A description of the pulse |
| | | event. |
| PULSE_SIZE | INTEGER | The size of the pulse to be |
| | | displayed on a visual interface |
| | | of an electronic device. |
| PULSE_LOCATION | INTEGER | The location of the pulse, |
| | | such as a single set of |
| | | coordinates defining a |
| | | point or a series of |
| | | coordinates bounding an area. |
| PULSE_COLOR | VARCHAR(6) | The hexadecimal color of the |
| | | pulse to be displayed. |
| PULSE_INTENSITY | VARCHAR(6) | A hexadecimal representation |
| | | of pulse intensity that should |
| | | be shown. Where intensity is |
| | | used, the PULSE_COLOR |
| | | field may be redundant and |
| | | may be omitted. |
| PULSE_OPACITY | INTEGER | An integer representation of |
| | | how transparent or opaque the |
| | | pulse should be. For instance, |
| | | “0” may indicate complete |
| | | transparency whereas “100” |
| | | may indicate a completely |
| | | opaque pulse. |
| PULSE_FREQ | INTEGER | An integer representation of |
| | | the number of times a pulse |
| | | should flash. For example, a |
| | | value of “1” may indicate that |
| | | the pulse should flash once |
| | | per minute whereas a value of |
| | | “60” may indicate that the |
| | | pulse should flash once per |
| | | second. |
| NUM_POSTS | INTEGER | The number of posts, such as |
| | | pictures, text messages, and |
| | | videos, that users have made |
| | | with respect to the pulse |
| | | event. |
| POST_LINK | VARCHAR(200) | A link to post content when |
| | | made via an external software |
| | | application. Alternatively, |
| | | post content may be acquired, |
| | | stored, and managed as part of |
| | | the pulse application. |

These data fields may be stored, managed, and provided by an application server located within a telecommunications network, for example. Further, certain fields may be omitted and/or other fields may be included as desired for the system design, and the fields may have any desired data type, size, and format. All or a subset of the data fields may be provided to a consuming application automatically via push functionality, at the request of the client device or user, or in any other suitable manner Further, different subsets of the data fields may be provided at different time intervals and/or by different mechanisms (for example, some may be requested by a client application on a user's electronic device and others may be pushed from a server).

Embodiments of the present invention have various features that a user may take advantage of. For instance, in some embodiments, users may access and view a map containing their location that shows nearby pulses, such as the map illustrated in FIG. 2. This functionality may be available via a web browser, a custom-tailored software application, or through any other suitable means, and may also be available on any suitable electronic device that either has GPS capabilities or has access to such data from another system.

Per the above, the visual attributes of the pulses may be a function of user activity relative to the pulse location. Users may also be able to activate a pulse on a map to see data correlating to visual attributes, such as the number of users at the location, the time for which the pulse has been active, user posts, the number of users that have checked in and/or left, etc. In some embodiments, pulses may begin and end at a predetermined time. Also, in some embodiments, users may automatically be checked in when they are proximate to a pulse location, whereas in other embodiments, users are either prompted to check in or must manually access the application to check in on their own volition. In certain embodiments, users can search for previous pulses based on a category, an area, location, or geographic region, and/or a time.

In some embodiments, users may post pictures, messages, videos, etc. when at a pulse location, and may view the posts of at least a subset of other users at the pulse location. In other embodiments, users at any location may post regarding a pulse. Users may view posts when they activate a pulse. In other words, when users click on a pulse to get information, they can scroll down through the posts that other users attending the pulse event/location have made. In some embodiments, users can also activate a GPS function on a pulse to receive directions to the pulse location. In certain embodiments, users may turn on or off location anonymity, groups, category interests, and automatic check in. Users may also set the application to send/receive data at different intervals of time to customize update frequency, which may also have the benefit of increasing battery life, where applicable. Users may further set times for a pulse to activate and deactivate.

Users may create groups based on a certain activity. Some of the attributes that may be included are group name, group type (family, friends, co-workers, etc.), interest type (sports, tailgating, knitting, etc.), users to add, etc. Users may also set pulses that are only viewable by a designated group. Users may also setup pulses in advance and notify their groups, any other sets of users, or in some embodiments all users, of upcoming events. In some embodiments, users may view top pulses for their interests based on data collected during a predetermined time period, such as the last week. In some embodiments, users may also scroll through upcoming sponsored events for their interests.

In some embodiments, a user who created a pulse may add or modify the attributes of the pulse, such as color, pulse name, pulse creator, time for the pulse to activate/deactivate, a picture to include with the pulse, a contact number, a pulse address, a group to associate with the pulse, other users to add or invite through a mechanism such as email or short message service (SMS), place the pulse on a map, etc. Business users may choose to set schedules for their pulses to be placed for customers, and may edit a pulse to show a name, logo, contact information, web link, customer specials, etc. that the business wishes to associate with the pulse. In some embodiments, certain users may sponsor public events that are accessible to all users. In some embodiments, users may have access to data reports pertaining to their pulses that show data such as the number of users that attended, the average time users stayed at the pulse event, a breakdown of transiency over multiple time intervals (such as every ten minutes for the duration of the event), etc.

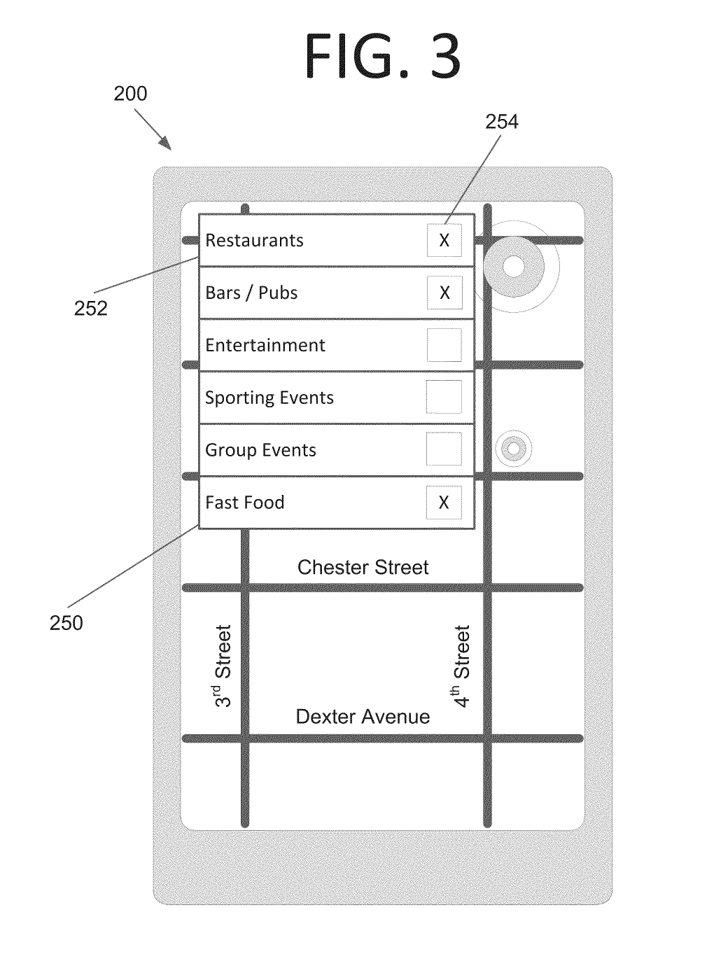

FIG. 3 illustrates a pulse category selection menu 250 on GPS-enabled electronic device 200, according to an embodiment of the present invention. Pulse category selection menu 250 has individual pulse categories 252 that a user can select or de-select via checkboxes 254. The pulse categories may be color-coded to match their corresponding pulses. However, the manner of pulse category selection and display is a matter of design choice. When selected, the pulses associated with a given pulse category may appear on the map screen if any such pulses are within the map view.

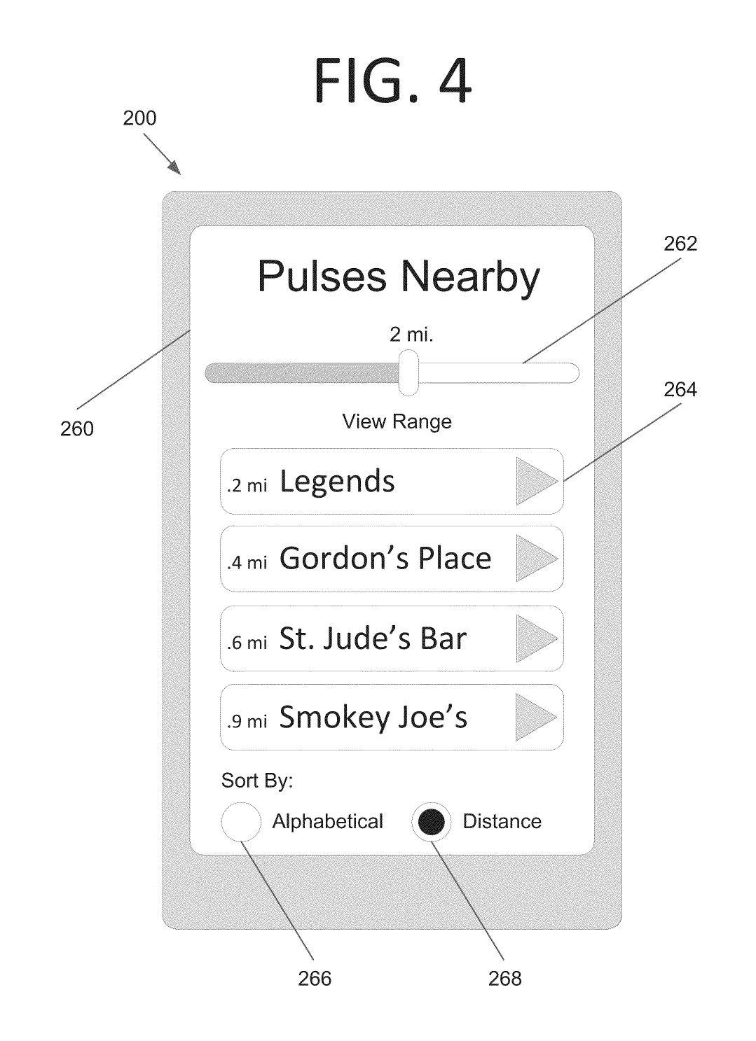

FIG. 4 illustrates a nearby pulses screen 260 on GPS-enabled electronic device 200, according to an embodiment of the present invention. Nearby pulses screen 260 includes a distance slider 262 that indicates the distance in which nearby pulses should be listed, and the currently selected distance is shown. In some embodiments, the listing may have pagination (not shown) to break longer results listings down into multiple display screens.

In this embodiment, four nearby pulse listings 264 are visible. Each pulse listing has the name of the pulse location and the distance. Two options for displaying pulses are present in this embodiment—alphabetical 266 and distance 268. However, any suitable sorting options may be used. In the present case, distance 268 is selected, and pulse listings 264 are sorted from the shortest distance from the user on the top to the longest distance from the user on the bottom.

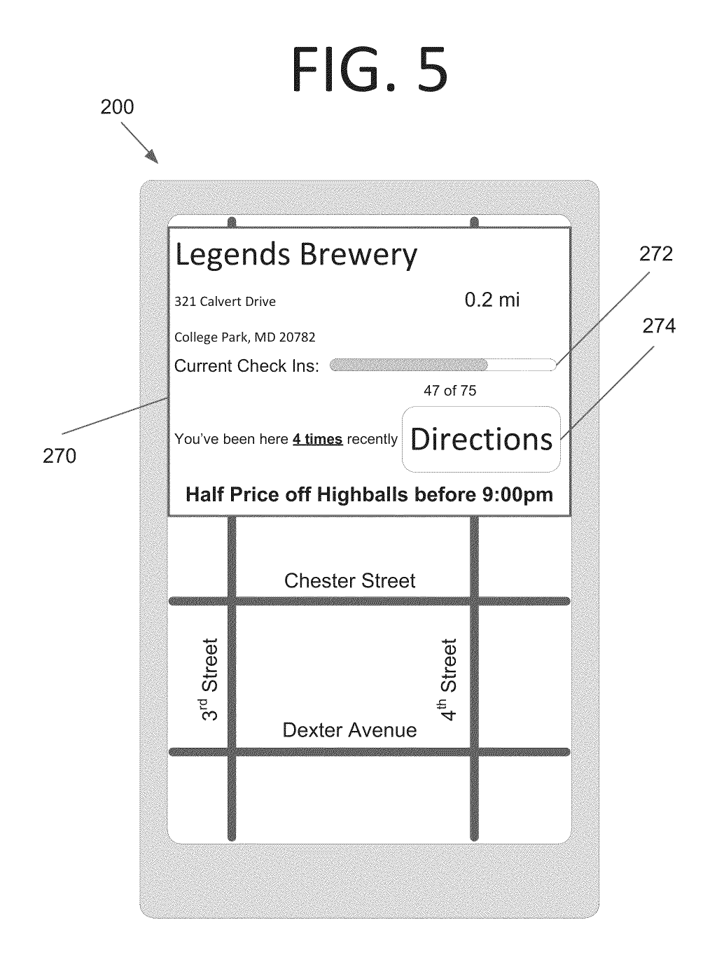

FIG. 5 illustrates a pulse description 270 on GPS-enabled electronic device 200, according to an embodiment of the present invention. Pulse description 270 includes the name of the pulse location (or event), the address, and the distance from the user to the pulse. In some embodiments, contact information may also be present. Pulse description 270 also shows the number of times that the user has visited the pulse location recently (which may be any desired time period, such as within the last month) and an advertisement for a special being offered during the pulse event.

A current check ins indicator 272 displays the number of users that have checked in versus the number of users that are expected. In some embodiments, the number of users that have checked in and then left the pulse location may be displayed. Pulse description 270 also includes a directions button 274 that allows the user to view directions from his or her current location to the pulse location.

The pulse description may contain any desired information. This information includes, but is not limited to, the activity type, the neighborhood the pulse is located in, the approximate number of users at the pulse location, the amount of time that the pulse has been active, a user option to check into the pulse and/or to simultaneously message a specific group of users, the option to scroll through pulse posts, the name of the establishment/location/area/event, an associated logo, a link to the establishment/organization's web site, etc.

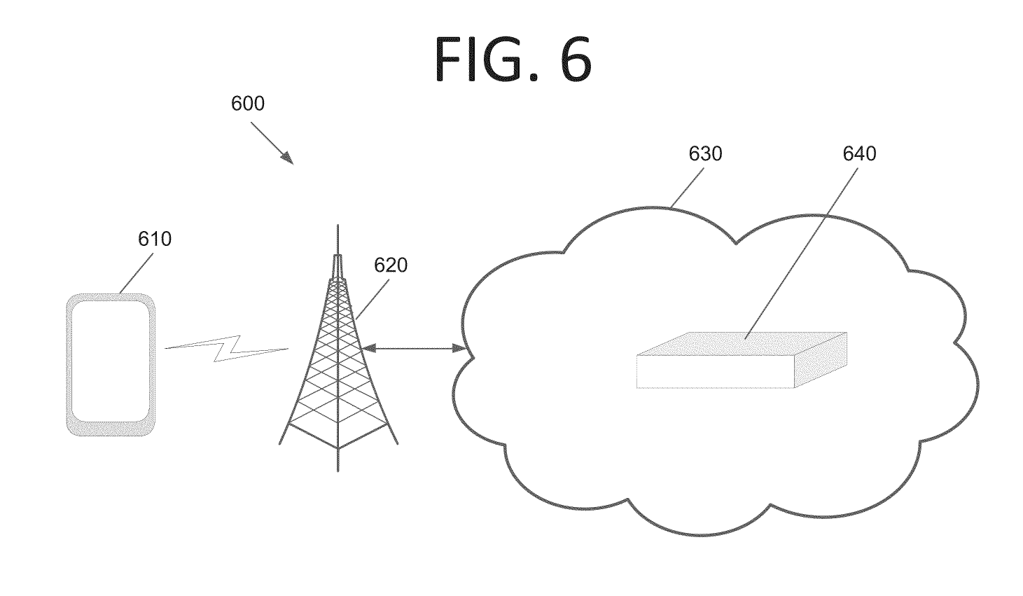

FIG. 6 illustrates a telecommunications system 600, in accordance with an embodiment of the present invention. Telecommunications system 600 may be any telecommunications system, such as those of any currently available carrier or combination of carriers, and may utilize any suitable standards and technologies, such as enhanced Node Bs, RNCs, 3G, 4G, etc., and may include LAN components in at least some embodiments. Telecommunications system 600 includes a cell phone 610, which may be GPS-enabled electronic device 200 of FIGS. 2-5 in some embodiments. Cell phone 610 wirelessly communicates with a base transceiver station (BTS) 620 that transmits data to, and receives data from, cell phone 610. BTS 620, in turn, communicates with the remainder of the telecommunications network 630, which may be of any desired architecture. Within telecommunications network 630 is an application server 640 that runs a server-side pulse application.

In some embodiments, the server-side pulse application may collect and manage pulse data from a plurality of users. The server-side pulse application may receive notifications from users' cell phones when they enter or leave a pulse location, when they make a post, etc. The server-side pulse application may further send notifications and data to users' cell phones periodically, based on certain triggers (such as a user's cell phone indicating that it has entered a certain pulse location), at the request of a user's cell phone, or at any other time by any other suitable mechanism.

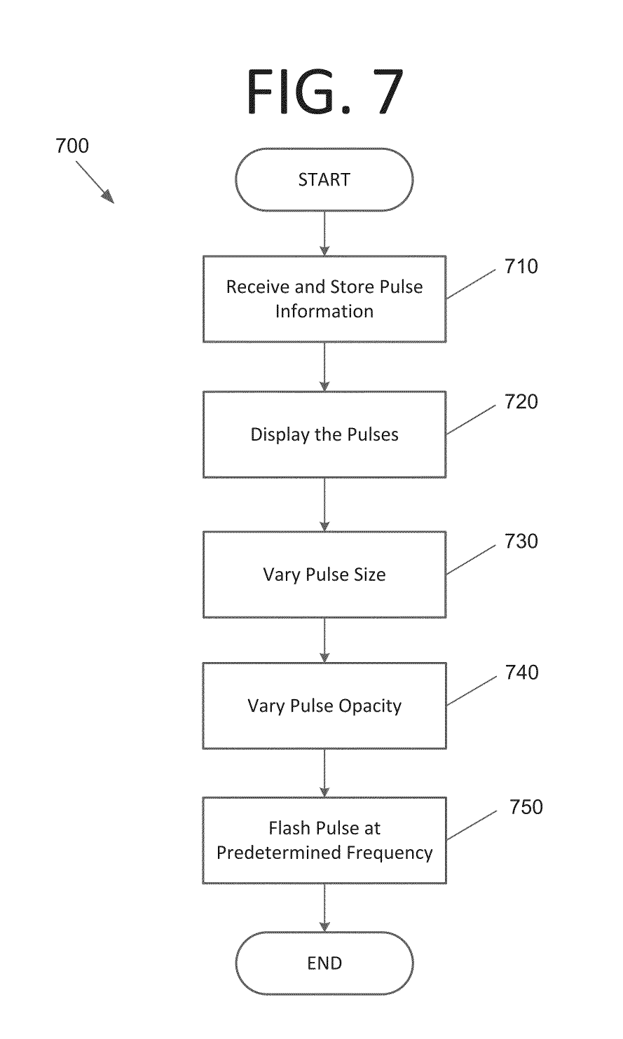

FIG. 7 illustrates a flowchart 700 of a method for facilitating a visual display based on a number of users at or near a location, according to an embodiment of the present invention. In some embodiments, the method of FIG. 7 may be performed by the GPS-enabled device of FIGS. 2-5, for example. The method begins with a user's electronic device receiving and storing information pertaining one or more pulses having respective locations at 710. Pulses may be always available or available during a predetermined time period, particularly when associated with a one-time event. Pulses associated with recurring events may be available periodically for the predetermined time period, such as from 6:00 pm to 9:00 pm every Wednesday for a certain recurring special. Further, each of the one or more pulses may be color-coded based on a type of category to which the respective pulse belongs.

The one or more pulses are displayed at positions corresponding to the respective locations on a mapping application via a display of an electronic device at 720. Visual attributes of the one or more pulses may pertain to, and be displayed based on, crowd data for a location or area associated with the pulse. The size of the one or more pulses is varied to correspond with a number of individuals that are present at the respective locations associated with the one or more pulses at 730. A predetermined display size may be set based on an expected number of users for at least one pulse. The size of the at least one pulse may be larger than the predetermined display size when more than the expected number of users check into the at least one pulse. Similarly, the size of the at least one pulse may be smaller than the predetermined display size when fewer than the expected number of users check into the at least one pulse. The “display size” and “predetermined display size” refer to the size of the pulse on the display screen.

The opacity of the pulses is varied based on the number of individuals that leave a pulse location during a predetermined period of time at 740. For example, the pulse may appear more opaque if few individuals are leaving the pulse location and more transparent of more individuals are leaving the pulse location in some embodiments. The pulse pulsates with a predetermined frequency based on a number of users that have entered a pulse location over a predetermined period of time or flashes based on a number of posts that users have made pertaining to the pulse at 750.

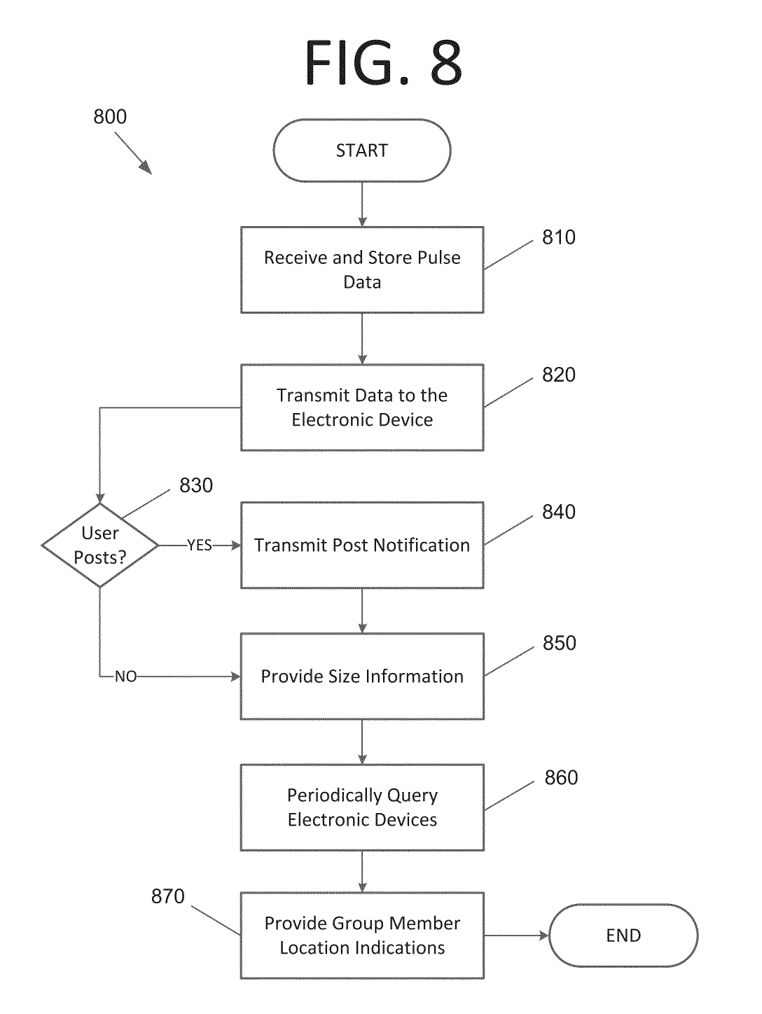

FIG. 8 is a flowchart 800 illustrating a method of collecting and managing pulse data for a plurality of users, according to an embodiment of the present invention. In some embodiments, the method may be performed by application server 640 of FIG. 6, for example. The method begins with receiving and storing data pertaining to a pulse at 810. In some embodiments, the data may pertain to one or more of a total number of users at a pulse location, a number of users entering the pulse location within a predetermined period of time, and a number of users leaving the pulse location within a predetermined period of time.

Data is then transmitted to at least one electronic device of a user, such as a cell phone, at 820. In some embodiments, the data may be transmitted to the at least one electronic device periodically, based on a trigger, or at the request of the at least one electronic device. If a user makes a post pertaining to a pulse at 830, a notification is transmitted to the at least one electronic device when the user makes the post at 840.

Sizing information is provided to the at least one electronic device regarding a scale of how large to draw a pulse with respect to a number of individuals at the pulse location at 850. Electronic devices of a plurality of users in a group associated with the pulse are periodically queried regarding their location at 860. An indication is provided to the at least one electronic device of the number of group members that are in the pulse location and the number of group members that are within a predetermined proximity of the pulse location at 870. In some embodiments, indications of the number of users within a predetermined number of proximity ranges from the pulse location are provided to the at least one electronic device. For instance, an indication may be provided for users at the pulse location, up to 5 miles from the pulse location, between 5-10 miles from the pulse location, etc.

Some embodiments of the present invention are directed to software that facilitates the display of graphical indicators (pulses) that represent crowd data in a novel way. Pulses have various attributes that provide a visual indication of how large a crowd is at a location, the number of users that are arriving at, and leaving from, a location. In this manner, users may view events/locations on a map and determine which location(s) appear attractive to visit.

The method steps performed in FIGS. 7 and 8 may be performed by a computer program, encoding instructions for the nonlinear adaptive processor to perform at least the methods described in FIGS. 7 and 8, in accordance with an embodiment of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 7 and 8, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
receiving and storing information pertaining one or more pulses having respective locations; and
displaying the one or more pulses at positions corresponding to the respective locations on a mapping application via a display of an electronic device, wherein
visual attributes of the one or more pulses pertain to, and are displayed based on, crowd data for a location or area associated with the pulse.

2. The computer-implemented method of claim 1, wherein the one or more pulses are always available, available during a predetermined time period, or both.

3. The computer-implemented method of claim 1, wherein each of the one or more pulses is color-coded based on a type of category to which the respective pulse belongs.

4. The computer-implemented method of claim 1, further comprising:
varying a size of the one or more pulses to correspond with a number of individuals that are present at the respective locations associated with the one or more pulses.

5. The computer-implemented method of claim 4, wherein a predetermined display size of the one or more pulses is set based on an expected number of users for at least one pulse, the size of the at least one pulse is larger than the predetermined display size of the at least one pulse when more than the expected number of users check into the at least one pulse, and the size of the at least one pulse is smaller than the predetermined display size of the at least one pulse when fewer than the expected number of users check into the at least one pulse.

6. The computer-implemented method of claim 1, further comprising:
varying an opacity of a pulse based on a number of individuals that leave a pulse location during a predetermined period of time.

7. The computer-implemented method of claim 1, further comprising:
flashing a pulse with a predetermined frequency based on a number of posts that users have made pertaining to the pulse.

8. An apparatus, comprising:
physical memory and a processor configured to read information from, and write information to, the physical memory; and
a display, wherein
the processor is configured to receive and store information pertaining one or more pulses having respective locations,
the display is configured to display the one or more pulses at positions corresponding to the respective locations on a mapping application via a display of an electronic device, and
visual attributes of the one or more pulses pertain to, and are displayed based on, crowd data for a location or area associated with the pulse.

9. The apparatus of claim 8, wherein the one or more pulses are always available, available during a predetermined time period, or both.

10. The apparatus of claim 8, wherein each of the one or more pulses is color-coded based on a type of category to which the respective pulse belongs.

11. The apparatus of claim 8, wherein the display is further configured to:
vary a size of the one or more pulses to correspond with a number of individuals that are present at the respective locations associated with the one or more pulses.

12. The apparatus of claim 11, wherein a predetermined display size of the one or more pulses is set based on an expected number of users for at least one pulse, the size of the at least one pulse is larger than the predetermined display size of the at least one pulse when more than the expected number of users check into the at least one pulse, and the size of the at least one pulse is smaller than the predetermined display size of the at least one pulse when fewer than the expected number of users check into the at least one pulse.

13. The apparatus of claim 8, wherein the display is further configured to vary an opacity of a pulse based on a number of individuals that leave a pulse location during a predetermined period of time.

14. The apparatus of claim 8, further comprising:
flashing a pulse with a predetermined frequency based on a number of posts that users have made pertaining to the pulse.

15. A computer-implemented method, comprising:
receiving and storing data pertaining to a pulse comprising a total number of users at a pulse location, a number of users entering the pulse location within a predetermined period of time, and a number of users leaving the pulse location within a predetermined period of time; and
transmitting the data to at least one electronic device.

16. The computer-implemented method of claim 15, wherein the transmitting comprises transmitting the data to the at least one electronic device periodically, based on a trigger, or at the request of the at least one electronic device.

17. The computer-implemented method of claim 15, further comprising:
transmitting a notification to the at least one electronic device when a user of another electronic device makes a post pertaining to the pulse.

18. The computer-implemented method of claim 15, further comprising:
providing sizing information to the at least one electronic device regarding a scale of how large to draw a pulse with respect to a number of individuals at the pulse location.

19. The computer-implemented method of claim 15, further comprising:
periodically querying electronic devices of a plurality of users in a group associated with the pulse regarding their location; and
providing an indication to the at least one electronic device of the number of group members that are in the pulse location and the number of group members that are within a predetermined proximity of the pulse location.

20. The computer-implemented method of claim 19, wherein indications of the number of users within a predetermined number of proximity ranges from the pulse location are provided to the at least one electronic device.
